(19) United States
(12) Patent Application Publication
(10) Pub. No.: US 2020/0126147 A1
(43) Pub. Date: Apr. 23, 2020

(54) ORDER PROMPTING METHOD AND DEVICE

(71) Applicant: Beijing Xiaomi Mobile Software Co., Ltd., Beijing (CN)

(72) Inventor: Yongli SUN, Beijing (CN)

(73) Assignee: Beijing Xiaomi Mobile Software Co., Ltd.

(21) Appl. No.: 16/550,875

(22) Filed: Aug. 26, 2019

(30) Foreign Application Priority Data
Oct. 19, 2018 (CN) 201811224764.3

(51) Int. Cl. G06Q 30/06

(52) U.S. Cl. CPC G06Q 30/0635; G06Q 30/0641

(57) ABSTRACT

An order prompting method includes: acquiring account information of an account placing an order and recipient information of the order, when the order is placed; determining a recipient account corresponding to the recipient information when it is determined that the account information of the account placing the order and the recipient information correspond to different accounts; and transmitting an order-placed prompt instruction for instructing a terminal logging in to the recipient account to prompt that the order has been placed.

### CROSS-REFERENCE TO RELATED APPLICATIONS

This application is based on and claims priority to Chinese Patent Application No. 201811224764.3, filed on Oct. 19, 2018, the entire content of which is incorporated herein by reference.

### TECHNICAL FIELD

The present disclosure relates to the field of Internet technology, and more particularly to an order prompting method and device.

### BACKGROUND

In recent years, with the rapid development of Internet technology, Internet has become one of indispensable tools in people's daily life, and network services are becoming more and more abundant, among which online shopping service is a relative common service. Online shopping refers to that a user uses a terminal to retrieve information of merchandise through the Internet and place an order to the server, in which the operation of placing an order may be understood as initiating a purchasing request for the merchandise in the order. The order generally includes recipient information, so as to facilitate an online shopping service provider to distribute the merchandise in the order according to the recipient information.

Through the online shopping service, the user may purchase merchandise not only for the user but also for a third party. When the user purchases the merchandise for the third party through the online shopping, it is sometimes difficult for the third party to learn that the user has purchased the merchandise for the third party, which may cause inconvenience, for example, the third party may refuse the order because the third party does not know that the user has purchased the merchandise for the third party, thereby degrading user experience.

### SUMMARY

According to a first aspect of embodiments of the present disclosure, there is provided an order prompting method, including: acquiring account information of an account placing an order and recipient information of the order when the order is placed; determining a recipient account corresponding to the recipient information when it is determined that the account information of the account placing the order and the recipient information correspond to different accounts; and transmitting an order-placed prompt instruction for instructing a terminal logging in to the recipient account to prompt that the order has been placed.

According to a second aspect of embodiments of the present disclosure, there is provided an order prompting device, including: a processor; and a memory for storing instructions executable by the processor. The processor is configured to: acquire account information of an account placing an order and recipient information of the order when the order is placed; determine a recipient account corresponding to the recipient information when it is determined that the account information of the account placing the order and the recipient information correspond to different accounts; and transmit an order-placed prompt instruction for instructing a terminal logging in to the recipient account to prompt that the order has been placed.

According to a third aspect of embodiments of the present disclosure, there is provided a non-transitory computer-readable storage medium having stored therein instructions that, when executed by a processor of a device, cause the device to perform an order prompting method, including: acquiring account information of an account placing an order and recipient information of the order when the order is placed; determining a recipient account corresponding to the recipient information when it is determined that the account information of the account placing the order and the recipient information correspond to different accounts; and transmitting an order-placed prompt instruction for instructing a terminal logging in to the recipient account to prompt that the order has been placed.

It is to be understood that both the foregoing general description and the following detailed description are exemplary and explanatory only and are not restrictive of the present disclosure, as claimed.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram illustrating an application scenario of an order prompting method according to an embodiment.

FIG. 2a is a flow chart illustrating an order prompting method according to an embodiment.

FIG. 2b is a flow chart illustrating an order prompting method according to an embodiment.

FIG. 2c is a flow chart illustrating an order prompting method according to an embodiment.

FIG. 2d is a flow chart illustrating an order prompting method according to an embodiment.

FIG. 3a is a block diagram illustrating an order prompting apparatus according to an embodiment.

FIG. 3b is a block diagram illustrating an order prompting apparatus according to an embodiment.

FIG. 3c is a block diagram illustrating an order prompting apparatus according to an embodiment.

FIG. 3d is a block diagram illustrating an order prompting apparatus according to an embodiment.

FIG. 4 is a block diagram illustrating a device according to an embodiment.

FIG. 5 is a block diagram illustrating a device according to an embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

The terminology used in the present disclosure is for the purpose of describing exemplary examples only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may also be referred to as second information; and similarly, second information may also be referred to as first information.

Reference throughout this specification to “an embodiment.” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

In order to solve the problem described in the Background, embodiments of the present disclosure provide an order prompting method, apparatus and device. With the order prompting method, apparatus and device, when an order is placed with, e.g., an online shopping service, information of an account placing the order, referred to herein as the order placing account, and recipient information of the order are acquired. When the order placing account information and the recipient information are determined to correspond to different accounts, for example, the order is placed by a user corresponding to the order placing account for a user corresponding to the recipient information, a recipient account corresponding to the recipient information is determined. The user corresponding to the recipient information is also referred to herein as a third party, and the recipient account is also referred to herein as a third-party account. An order-placed prompt instruction is further transmitted for instructing a terminal logging in to the recipient account (i.e., a terminal logging in to the third-party account) to prompt that the order has been placed. Accordingly, the terminal logging in to the third-party account is able to prompt the third party that someone (i.e., the user corresponding to the order placing account) has placed an order for the third party. In this way, when a user places an order for a third party, the third party may learn that the user has placed the order for the third party, thereby avoiding inconvenience and improving user experience, such as avoiding the third party to refuse the order because the third party does not know the user has placed the order for the third party.

Embodiments of the present disclosure provide an order prompting method, including: acquiring account information of an account placing an order and recipient information of an order when the order is placed: determining a recipient account corresponding to the recipient information when it is determined that the account information of the account placing the order and the recipient information correspond to different accounts; and transmitting an order-placed prompt instruction for instructing a terminal logging in to the recipient account to prompt that the order has been placed.

In an embodiment, the order prompting method further includes: transmitting an order prompt sharing request message to a terminal logging in to the account placing the order, to instruct the terminal logging in to the account placing the order to prompt its user to input a prompt confirmation instruction, after it is determined that the account information of the account placing the order and the recipient information correspond to different accounts and prior to transmitting the order-placed prompt instruction. Transmitting the order-placed prompt instruction includes: receiving the prompt confirmation instruction, and transmitting the order-placed prompt instruction in response to the prompt confirmation instruction.

In an embodiment, the order prompting method further includes: acquiring order information of the order. Transmitting the order-placed prompt instruction includes: transmitting the order-placed prompt instruction and the order information. The order-placed prompt instruction is configured to instruct the terminal logging in to the recipient account to prompt that the order has been placed and to display the order information.

In an embodiment, the order prompting method further includes: transmitting an order information selection request message to the terminal logging in to the account placing the order, to instruct the terminal logging in to the account placing the order to prompt its user to select the order information; and receiving an order information selection confirmation instruction and determining selected order information according to the order information selection confirmation instruction. Transmitting the order-placed prompt instruction and the order information includes: transmitting the order-placed prompt instruction and the selected order information. The order-placed prompt instruction is configured to instruct the terminal logging in to the recipient account to prompt that the order has been placed and to display the selection order information.

In an embodiment, the account information of the account placing the order includes a communication mode of a user placing the order, and the recipient information includes a communication mode of a recipient of the order.

In an embodiment, the account information of the account placing the order includes an address of a user placing the order, and the recipient information includes an address of a recipient of the order.

In an embodiment, the account information of the account placing the order includes a payment account of a user placing the order, and the recipient information includes a payment account of a recipient of the order.

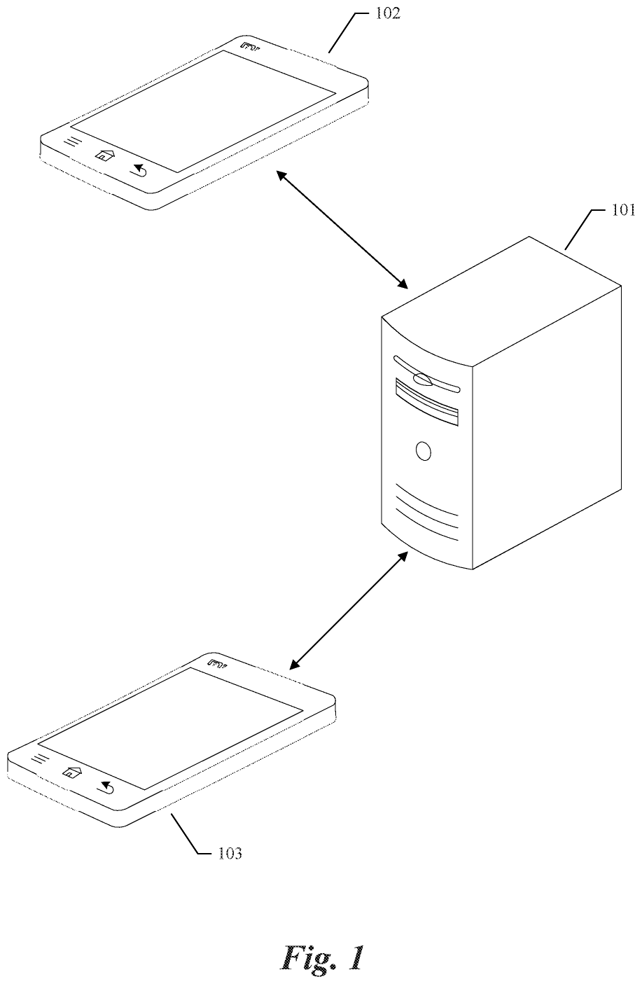

FIG. 1 is a schematic diagram illustrating an application scenario of the order prompting method according to an embodiment. The application scenario includes a server 101, an order placing terminal (i.e., a terminal logging in to an account placing an order, referred to herein as an order placing account) and a third-party terminal (i.e., a terminal logging in to a recipient account). Both the order placing terminal 102 and the third-party terminal 103 may be mobile phones, tablets, smart wearable devices, and other devices capable of interacting with the server 101, which are not limited by embodiments of the present disclosure. In embodiments of the present disclosure, the server 101 may be a device for providing computing services that is provided and used by an online shopping service operator. Alternatively, the server 101 may also be a device for providing computing services that is provided by a network operator and used by an online shopping service operator. The server 101 establishes data connections with the order placing terminal 102 and the third-party terminal 103 via wireless communication network, respectively.

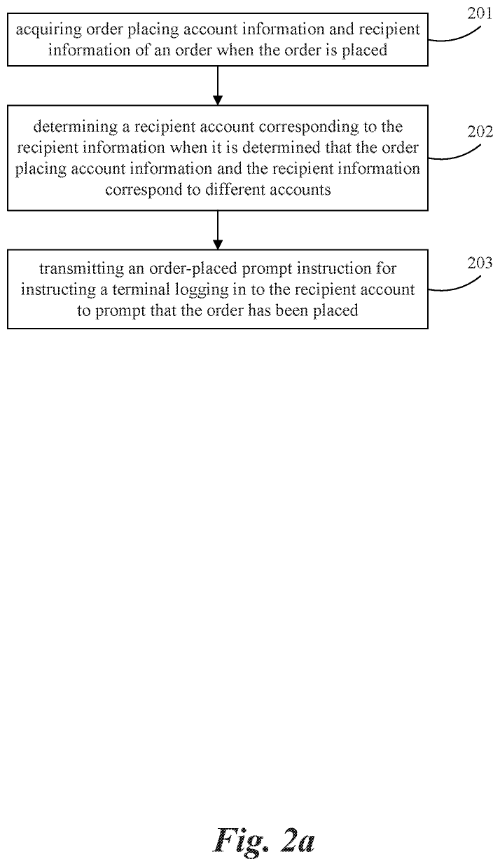

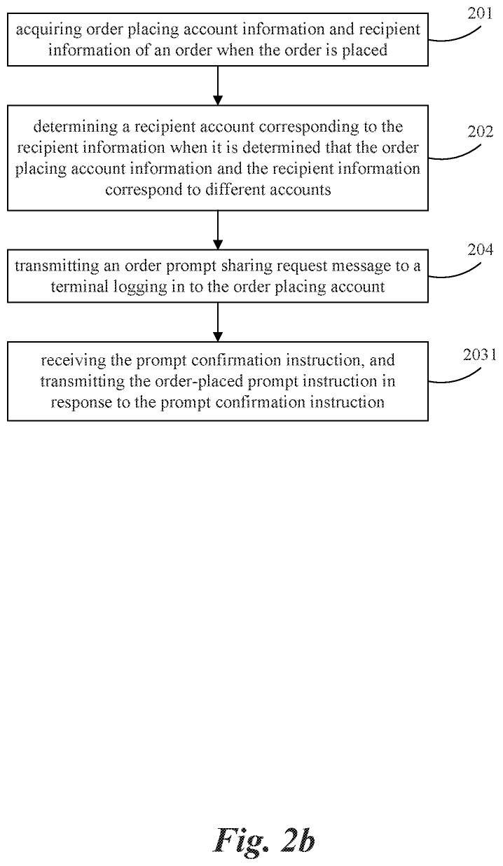

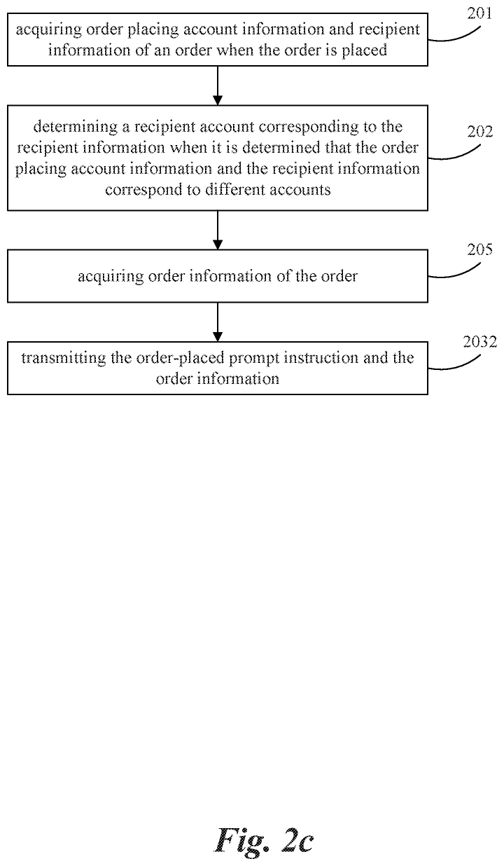

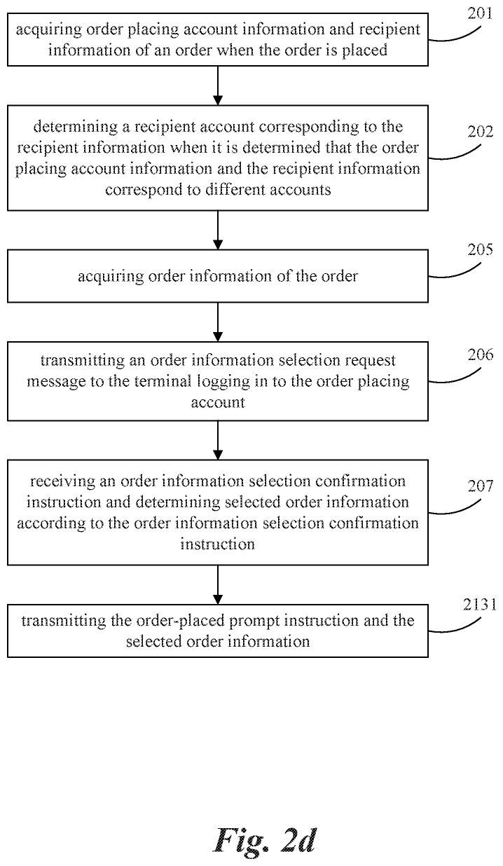

FIG. 2a is a flow chart of an order prompting method according to an embodiment. The method may be applied to a server, and includes the following operations as illustrated at blocks shown in FIG. 2a.

At block 201, order placing account information and recipient information of an order are acquired when the order is placed.

In an embodiment, the order is placed when the server receives an order placing confirmation message transmitted by an order placing terminal. The order placing confirmation message may include an order number of the order. The server is able to make further search according to the order number so as to acquire the order placing account information and the recipient information of the order. In an embodiment, the order placing confirmation message may include the order number of the order, an identifier of merchandise in the order, the recipient information and the order placing account information of the order, and the server may directly extract the order placing account information and the recipient information of the order from the order placing confirmation message.

The order placing account information and the recipient information may include account information in the same format, and it may be determined by comparing the order placing account information and the recipient information that the order placing account and a recipient account corresponding to the recipient information are registered by different users.

For example, the order placing account information may include a communication mode of a user placing the order, and the recipient information may include a communication mode of a recipient of the order. Also for example, the order placing account information may include an address of a user placing the order, and the recipient information may include an address of a recipient of the order. As another example, the order placing account information may include a payment account of a user placing the order, and the recipient information may include a payment account of a recipient of the order.

At block 202, a recipient account corresponding to the recipient information is determined when the order placing account information and the recipient information are determined to correspond to different accounts.

In an embodiment, the order placing account information and the recipient information correspond to different accounts. For example, part or all of the order placing account information is registered by the order placing account, while part or all of the recipient information is registered by the recipient account, and the order placing account and the recipient account are different accounts.

In an embodiment, the recipient account corresponding to the recipient information may be determined by performing searches according to the part or all of the recipient information and determining the recipient account corresponding to the recipient information based on search results.

At block 203, an order-placed prompt instruction is transmitted for instructing a terminal logging in to the recipient account to prompt that the order has been placed.

In an embodiment, the order-placed prompt instruction may be transmitted to the terminal logging in to the recipient account by a point-to-point way. As another example, the order-placed prompt instruction may be transmitted to the terminal logging in to the recipient account by a broadcasting way, and the terminal logging in to the recipient account will respond when receiving the broadcasted order-placed prompt instruction, while a terminal not logging in to the recipient account will not respond when receiving the broadcasted order-placed prompt instruction.

In an embodiment, the order-placed prompt instruction may be used to instruct the terminal logging in to the recipient account to display a prompt text or a prompt image in a corresponding online shopping application (APP) so as to prompt that the order in which the recipient is a user corresponding to the recipient account has been placed.

In the order prompting method according to embodiments of the present disclosure, when the order is placed, the order placing account information and the recipient information of the order are acquired; when the order placing account information and the recipient information are determined to correspond to different accounts, that is, the order is placed by a user corresponding to the order placing account for a user corresponding to the recipient information (i.e., a third party), the recipient account corresponding to the recipient information (i.e., a third-party account) is determined; and the order-placed prompt instruction is transmitted for instructing the terminal logging in to the recipient account (i.e., a terminal logging in to the third-party account) to prompt that the order has been placed. Accordingly, the terminal logging in to the third-party account is able to prompt the third party that someone (i.e., the user corresponding to the order placing account) has placed an order for the third party. In this way, when a user places an order for a third party, the third party may learn that the user has placed the order for the third party, thereby avoiding inconvenience and improving user experience, such as avoiding the third party to refuse the order because the third party does not know the user has placed the order for the third party.

In an embodiment, as illustrated in FIG. 2b, after the operation as described at block 202 and before the operation as described at block 203, the order prompting method further includes an operation as illustrated at block 204.

At block 204, an order prompt sharing request message is transmitted to a terminal logging in to the order placing account.

In an embodiment, the order prompt sharing request message is configured to instruct the terminal logging in to the order placing account to prompt its user to input a prompt confirmation instruction.

In an embodiment, the operation that an order-placed prompt instruction is transmitted as described at block 203 may be implemented by an operation as illustrated at block 2031.

At block 2031, the prompt confirmation instruction is received, and the order-placed prompt instruction is transmitted in response to the prompt confirmation instruction.

In an embodiment, when receiving the order prompt sharing request message, the terminal logging in to the order placing account may display a shortcut option for sharing the order information to the recipient account in an order displaying interface of a corresponding application, and may further display corresponding prompt information to prompt the user to use the terminal logging in to the order placing account to share the order information to the recipient account or the terminal logging in to the recipient account. When the user corresponding to the order placing account clicks the shortcut option for sharing the order information to the recipient account, the terminal logging in to the order placing account may transmit the prompt confirmation instruction to the server. When receiving the prompt confirmation instruction, the server may mark the order as an order to be shared to the recipient account, and transmit the order-placed prompt instruction to the terminal logging in to the recipient account. When receiving the order-placed prompt instruction, the terminal logging in to the recipient account may display the corresponding prompt information so as to prompt the user corresponding to the recipient account that someone has purchased merchandize for the user, and the user corresponding to the recipient account may log in to the corresponding application using the recipient account to check the order.

By transmitting the order prompt sharing request message to make the terminal logging in to the order placing account prompt its user to input the prompt confirmation instruction in response to the order prompt sharing request message; receiving the prompt confirmation instruction; and transmitting the order-placed prompt instruction in response to the prompt confirmation instruction, it is ensured that only with the permission of the user corresponding to the order placing account can the terminal logging in to the recipient account prompt that the order has been placed, thereby avoiding a false prompt of the terminal logging in to the recipient account when the user corresponding to the order placing account does not want to prompt the user corresponding to the recipient account that the order has been placed for the user corresponding to the recipient account.

In an embodiment, as illustrated in FIG. 2c, the order prompting method further includes an operation as illustrated at block 205.

At block 205, order information of the order is acquired.

In an embodiment of the present disclosure, the operation that an order-placed prompt instruction is transmitted as described at block 203 may be implemented by an operation as illustrated at block 2032.

At block 2032, the order-placed prompt instruction and the order information are transmitted.

In an embodiment, the order-placed prompt instruction is configured to instruct the terminal logging in to the recipient account to prompt that the order has been placed and to display the order information.

In an embodiment, the order information may include at least one selected from the order number, text or picture information of merchandise in the order, a network link of the merchandise in the order, logistics information of the merchandise in the order, and the order placing account information of the order.

By acquiring the order information of the order and transmitting the order-placed prompt instruction and the order information to make the terminal logging in to the recipient account prompt that the order has been placed in response to the order-placed prompt instruction and display the order information, it is ensured that when a user places an order for a third party, the third party not only may learn that the user has placed the order for the third party, but also may learn details of the order, which is convenient for the third party to further learn the merchandise in the order or to receive the merchandise in the order, thereby improving user experience.

In an embodiment, as illustrated in FIG. 2d, the order prompting method further includes operations as illustrated at blocks 206 to 207.

At block 206, an order information selection request message is transmitted to the terminal logging in to the order placing account.

The order information selection request message is configured to instruct the terminal logging in to the order placing account to prompt its user to select the order information.

At block 207, an order information selection confirmation instruction is received, and selected order information is determined according to the order information selection confirmation instruction.

In an embodiment of the present disclosure, the operation that the order-placed prompt instruction and the order information are transmitted as described at block 2032 may be implemented by an operation as illustrated at block 2131.

At block 2131, the order-placed prompt instruction and the selected order information are transmitted. The order-placed prompt instruction is configured to instruct the terminal logging in to the recipient account to prompt that the order has been placed and to display the selected order information.

By transmitting the order information selection request message to make the terminal logging in to the order placing account select the order information in response to the order information selection confirmation instruction; receiving the order information selection confirmation instruction; determining the selected order information according to the order information selection confirmation instruction; and transmitting the order-placed prompt instruction and the selected order information to instruct the terminal logging in to the recipient account to prompt that the order has been placed and display the selected order information in response to the order-placed prompt instruction, it is convenient for the user corresponding to the order placing account to select the order information to be displayed to the user corresponding to the recipient account, thus avoiding the display of information that the user corresponding to the order placing account does not want to provide to the user corresponding to the recipient account, thereby protecting the privacy of the user corresponding to the order placing account, and improving user experience.

In the following, an order prompting apparatus will be illustrated with reference to embodiments of the present disclosure, which may be used to implement the order prompting method as described above.

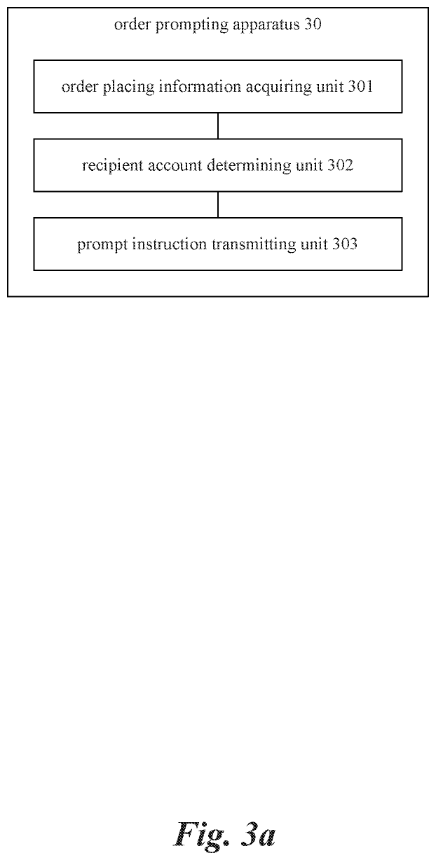

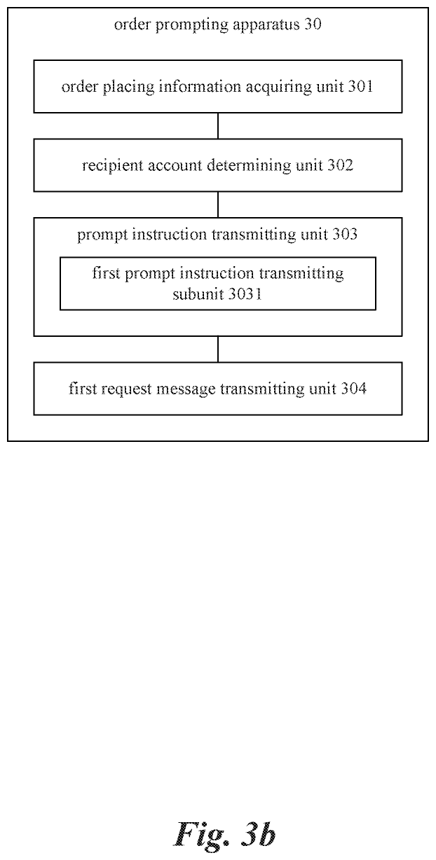

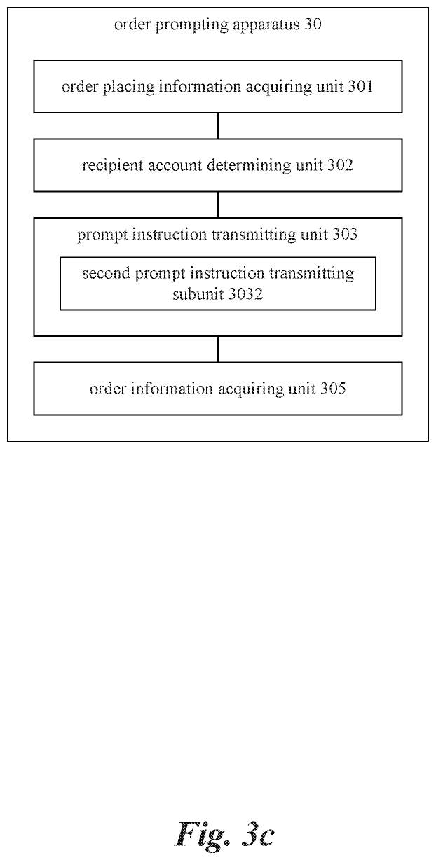

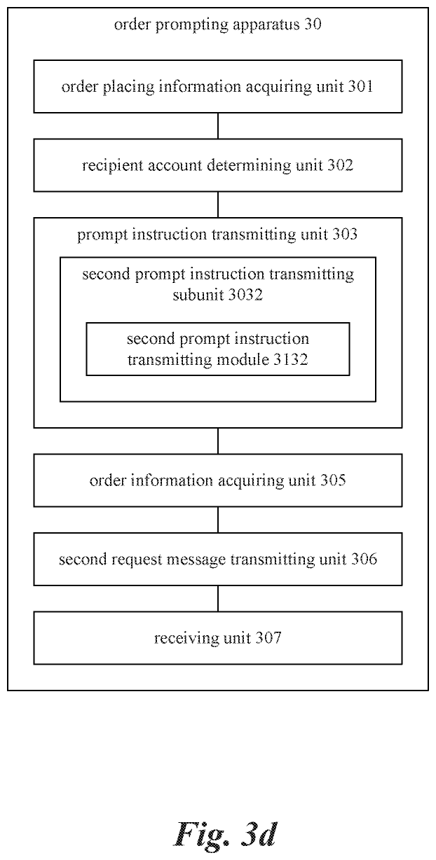

FIG. 3a is a block diagram illustrating an order prompting apparatus 30 according to an embodiment. The order prompting apparatus 30 may be a server or a part of the server. The order prompting apparatus 30 may be implemented as a part or the whole of an electronic device by software, hardware, or a combination thereof. As illustrated in FIG. 3a, the order prompting apparatus 30 includes: an order placing information acquiring unit 301, a recipient account determining unit 302, and a prompt instruction transmitting unit 303.

The order placing information acquiring unit 301 is configured to acquire order placing account information and recipient information of an order when the order is placed.

The recipient account determining unit 302 is configured to determine a recipient account corresponding to the recipient information when it is determined that the order placing account information and the recipient information correspond to different accounts.

The prompt instruction transmitting unit 303 is configured to transmit an order-placed prompt instruction for instructing a terminal logging in to the recipient account to prompt that the order has been placed.

In an embodiment, as illustrated in FIG. 3b, the order prompting apparatus 30 further includes: a first request message transmitting unit 304 configured to transmit an order prompt sharing request message to a terminal logging in to the order placing account for instructing the terminal logging in to the order placing account to prompt its user to input a prompt confirmation instruction.

In an embodiment, the prompt instruction transmitting unit 303 includes a first prompt instruction transmitting subunit 3031 configured to receive the prompt confirmation instruction and transmit the order-placed prompt instruction in response to the prompt confirmation instruction.

In an embodiment, as illustrated in FIG. 3c, the order prompting apparatus 30 further includes an order information acquiring unit 305 configured to acquire order information of the order.

In an embodiment, the prompt instruction transmitting unit 303 includes a second prompt instruction transmitting subunit 3032 configured to transmit the order-placed prompt instruction and the order information. The order-placed prompt instruction is configured to instruct the terminal logging in to the recipient account to prompt that the order has been placed and to display the order information.

In an embodiment, as illustrated in FIG. 3d, the order prompting apparatus 30 further includes a second request message transmitting unit 306 and a receiving unit 307.

The second request message transmitting unit 306 is configured to transmit an order information selection request message to the terminal logging in to the order placing account for instructing the terminal logging in to the order placing account to prompt its user to select the order information

The receiving unit 307 is configured to receive an order information selection confirmation instruction and determine selected order information according to the order information selection confirmation instruction.

The second prompt instruction transmitting subunit 3032 includes a second prompt instruction transmitting module 3132 configured to transmit the order-placed prompt instruction and the selected order information. The order-placed prompt instruction is configured to instruct the terminal logging in to the recipient account to prompt that the order has been placed and to display the selected order information.

In an embodiment, the order placing account information includes a communication mode of a user placing the order, and the recipient information includes a communication mode of a recipient of the order. In an embodiment, the order placing account information includes an address of a user placing the order, and the recipient information includes an address of a recipient of the order. In an embodiment, the order placing account information includes a payment account of a user placing the order, and the recipient information includes a payment account of a recipient of the order.

The order prompting apparatus according to embodiments of the present disclosure can acquire the order placing account information and the recipient information of the order when the order is placed; determine the recipient account corresponding to the recipient information (i.e., a third-party account) when it is determined that the order placing account information and the recipient information correspond to different accounts, for example, the order is placed by a user corresponding to the order placing account for a user corresponding to the recipient information (i.e., a third party); and transmit the order-placed prompt instruction for instructing the terminal logging in to the recipient account (i.e., a terminal logging in to the third-party account) to prompt that the order has been placed. Accordingly, the terminal logging in to the third-party account can prompt the third party that someone (i.e., the user corresponding to the order placing account) has placed an order for the third party. In this way, when a user places an order for a third party, the third party may learn that the user has placed the order for the third party, thereby avoiding inconvenience and improving user experience, such as avoiding the third party to refuse the order because the third party does not know the user has placed the order for the third party.

Embodiments of the present disclosure further provide an order prompting device, including: a processor; and a memory for storing instructions executable by the processor. The processor is configured to: acquire order placing account information and recipient information of an order when the order is placed; determine a recipient account corresponding to the recipient information when it is determined that the order placing account information and the recipient information correspond to different accounts; and transmit an order-placed prompt instruction for instructing a terminal logging in to the recipient account to prompt that the order has been placed.

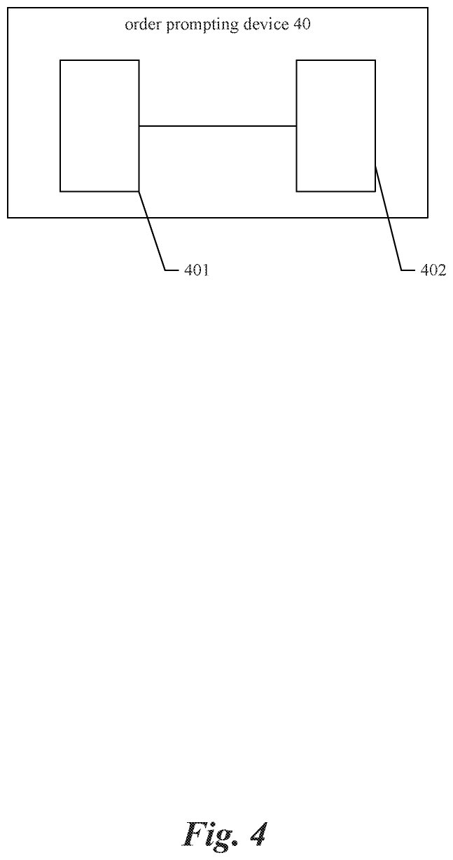

FIG. 4 is a block diagram illustrating an order prompting device 40 according to an embodiment of the present disclosure. The order prompting device 40 may be a server or a part of the server, and includes: a processor 401; and a memory 402 for storing instructions executable by the processor 401. The processor 401 is configured to: acquire order placing account information and recipient information of an order when the order is placed; determine a recipient account corresponding to the recipient information when it is determined that the order placing account information and the recipient information correspond to different accounts; and transmit an order-placed prompt instruction for instructing a terminal logging in to the recipient account to prompt that the order has been placed.

In an embodiment, the processor 401 may also be configured to transmit an order prompt sharing request message to a terminal logging in to the order placing account for instructing the terminal logging in to the order placing account to prompt its user to input a prompt confirmation instruction, after it is determined that the order placing account information and the recipient information correspond to different accounts and prior to transmitting the order-placed prompt instruction.

In an embodiment, the processor 401 is further configured to: receive the prompt confirmation instruction, and transmit the order-placed prompt instruction in response to the prompt confirmation instruction.

In an embodiment, the processor 401 may also be configured to acquire order information of the order. The processor 401 is further configured to: transmit the order-placed prompt instruction and the order information. The order-placed prompt instruction is configured to instruct the terminal logging in to the recipient account to prompt that the order has been placed and to display the order information.

In an embodiment, the processor 401 may also be configured to: transmit an order information selection request message to the terminal logging in to the order placing account for instructing the terminal logging in to the order placing account to prompt its user to select the order information; and receive an order information selection confirmation instruction and determine selected order information according to the order information selection confirmation instruction. The processor is further configured to: transmit the order-placed prompt instruction and the selected order information. The order-placed prompt instruction is configured to instruct the terminal logging in to the recipient account to prompt that the order has been placed and to display the selected order information.

In an embodiment, the order placing account information includes at least one of a communication mode, an address, or a payment account of a user placing the order; and the recipient information includes at least one of a communication mode, an address, or a payment account of a recipient of the order.

In an embodiment, the order placing account information includes the communication mode of the user placing the order, and the recipient information includes the communication mode of the recipient of the order. In an embodiment, the order placing account information includes the address of the user placing the order, and the recipient information includes the address of the recipient of the order. IN an embodiment, the order placing account information includes the payment account of the user placing the order, and the recipient information includes the payment account of the recipient of the order.

The order prompting device according to embodiments of the present disclosure can acquire the order placing account information and the recipient information of the order when the order is placed; determine the recipient account corresponding to the recipient information (i.e., a third party account) when it is determined that the order placing account information and the recipient information correspond to different accounts, that is, the order is an order placed by a user corresponding to the order placing account for a user corresponding to the recipient information (i.e., a third party); and transmit the order-placed prompt instruction for instructing the terminal logging in to the recipient account (i.e., a terminal logging in to the third-party account) to prompt that the order has been placed. Accordingly, the terminal logging in to the third-party account can prompt the third party that someone (i.e., the user corresponding to the order placing account) has placed an order for the third party. In this way, when a user places an order for a third party, the third party may learn that the user has placed the order for the third party, thereby avoiding inconvenience and improving user experience, such as avoiding the third party to refuse the order because the third party does not know the user has placed the order for the third party.

Embodiments of the present disclosure further provided a non-transitory computer-readable storage medium having stored therein computer instructions that, when executed by a processor, cause the processor to perform the order prompting method as described in any of embodiments in the first aspect of the present disclosure.

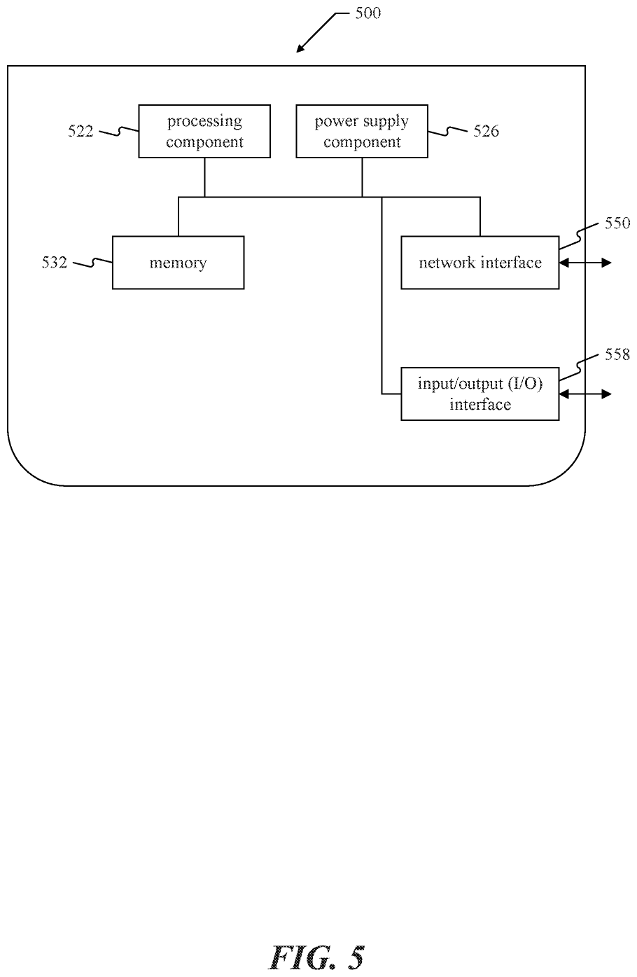

FIG. 5 is a block diagram illustrating an order prompting device 500 according to an embodiment. For example, the device 500 may be provided as a server. The device 500 includes a processing component 522, and memory resource represented by a memory 532 for storing instructions (such as application programs) executable by the processing component 522. The application programs stored in the memory 532 may include one or more modules, and each module may include a set of instructions. Further, the processing component 522 may be configured to execute the sets of instructions, so as to perform the methods described above.

The device 500 may also include a power supply component 526 configured to perform power management of the device 500, a wired or wireless network interfaces 550 configured to connect the device 500 to a network, and an input/output (I/O) interface 558. The device 500 may operate an operating system stored in the memory 532, such as Windows Server™, Mac OS X™, Unix™, Linux™, FreeBSD™, or the like.

Embodiments of the present disclosure further provide a non-transitory computer-readable storage medium having stored therein instructions that, when executed by a processor of a device, cause the device to perform: acquiring order placing account information and recipient information of an order when the order is placed; determining a recipient account corresponding to the recipient information when it is determined that the order placing account information and the recipient information correspond to different accounts; and transmitting an order-placed prompt instruction for instructing a terminal logging in to the recipient account to prompt that the order has been placed.

In an embodiment, the instructions further cause the device to perform: transmitting an order prompt sharing request message to a terminal logging in to the order placing account for instructing the terminal logging in to the order placing account to prompt its user to input a prompt confirmation instruction, after it is determined that the order placing account information and the recipient information correspond to different accounts and prior to transmitting the order-placed prompt instruction. The instructions further cause the device to perform: receiving the prompt confirmation instruction, and transmitting the order-placed prompt instruction in response to the prompt confirmation instruction.

In an embodiment, the instructions further cause the device to perform: acquiring order information of the order. The instructions further cause the device to perform: transmitting the order-placed prompt instruction and the order information. The order-placed prompt instruction is configured to instruct the terminal logging in to the recipient account to prompt that the order has been placed and to display the order information.

In an embodiment, the instructions further cause the processor to perform: transmitting an order information selection request message to the terminal logging in to the order placing account for instructing the terminal logging in to the order placing account to prompt its user to select the order information; and receiving an order information selection confirmation instruction and determining selected order information according to the order information selection confirmation instruction. The instructions further cause the device to perform: transmitting the order-placed prompt instruction and the selected order information. The order-placed prompt instruction is configured to instruct the terminal logging in to the recipient account to prompt that the order has been placed and to display the selected order information.

In an embodiment, the order placing account information includes a communication mode of a user placing the order, and the recipient information includes a communication mode of a recipient of the order. In an embodiment, the order placing account information includes an address of a user placing the order, and the recipient information includes an address of a recipient of the order. In an embodiment, the order placing account information includes a payment account of a user placing the order, and the recipient information includes a payment account of a recipient of the order.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the system disclosed may encompass software, firmware, and hardware implementations. The terms “module” and “unit” may include memory (shared, dedicated, or group) that stores code or instructions that can be executed by one or more processors.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only.

It will be appreciated that the present disclosure is not limited to the exact construction that has been described above and illustrated in the accompanying drawings, and that various modifications and changes can be made without departing from the scope thereof.

What is claimed is:

1. An order prompting method, comprising:
acquiring account information of an account placing an order and recipient information of the order, when the order is placed;
determining a recipient account corresponding to the recipient information when it is determined that the account information of the account placing the order and the recipient information correspond to different accounts; and
transmitting an order-placed prompt instruction for instructing a terminal logging in to the recipient account to prompt that the order has been placed.

2. The order prompting method according to claim 1, further comprising:
transmitting an order prompt sharing request message to a terminal logging in to the account placing the order, to instruct the terminal logging in to the account placing the order to prompt its user to input a prompt confirmation instruction, after it is determined that the account information of the account placing the order and the recipient information correspond to different accounts and prior to transmitting the order-placed prompt instruction,
wherein transmitting the order-placed prompt instruction comprises:
receiving the prompt confirmation instruction, and transmitting the order-placed prompt instruction in response to the prompt confirmation instruction.

3. The order prompting method according to claim 1, further comprising: acquiring order information of the order,
wherein transmitting the order-placed prompt instruction comprises:
transmitting the order-placed prompt instruction and the order information, wherein the order-placed prompt instruction is configured to instruct the terminal logging in to the recipient account to prompt that the order has been placed and to display the order information.

4. The order prompting method according to claim 3, further comprising:
transmitting an order information selection request message to the terminal logging in to the account placing the order, to instruct the terminal logging in to the account placing the order to prompt its user to select the order information; and
receiving an order information selection confirmation instruction and determining selected order information according to the order information selection confirmation instruction,
wherein transmitting the order-placed prompt instruction and the order information comprises:
transmitting the order-placed prompt instruction and the selected order information, wherein the order-placed prompt instruction is configured to instruct the terminal logging in to the recipient account to prompt that the order has been placed and to display the selected order information.

5. The order prompting method according to claim 1, wherein the account information of the account placing the order comprises a communication mode of a user placing the order, and the recipient information comprises a communication mode of a recipient of the order.

6. The order prompting method according to claim 1, wherein the account information of the account placing the order comprises an address of a user placing the order, and the recipient information comprises an address of a recipient of the order.

7. The order prompting method according to claim 1, wherein the account information of the account placing the order comprises a payment account of a user placing the order, and the recipient information comprises a payment account of a recipient of the order.

8. An order prompting device, comprising:
a processor; and
a memory for storing instructions executable by the processor;
wherein the processor is configured to:
acquire account information of an account placing an order and recipient information of the order, when the order is placed;
determine a recipient account corresponding to the recipient information when it is determined that the account information of the account placing the order and the recipient information correspond to different accounts; and
transmit an order-placed prompt instruction for instructing a terminal logging in to the recipient account to prompt that the order has been placed.

9. The order prompting device according to claim 8, wherein the processor is further configured to:
transmit an order prompt sharing request message to a terminal logging in to the account placing the order, to instruct the terminal logging in to the account placing the order to prompt its user to input a prompt confirmation instruction, after it is determined that the account information of the account placing the order and the recipient information correspond to different accounts and prior to transmitting the order-placed prompt instruction, and
receive the prompt confirmation instruction, and transmit the order-placed prompt instruction in response to the prompt confirmation instruction.

10. The order prompting device according to claim 8, wherein the processor is further configured to:
acquire order information of the order; and
transmit the order-placed prompt instruction and the order information, wherein the order-placed prompt instruction is configured to instruct the terminal logging in to the recipient account to prompt that the order has been placed and to display the order information.

11. The order prompting device according to claim 10, wherein the processor is further configured to:
transmit an order information selection request message to the terminal logging in to the account placing the order, to instruct the terminal logging in to the account placing the order to prompt its user to select the order information;
receive an order information selection confirmation instruction and determine selected order information according to the order information selection confirmation instruction; and
transmit the order-placed prompt instruction and the selected order information, wherein the order-placed prompt instruction is configured to instruct the terminal logging in to the recipient account to prompt that the order has been placed and to display the selected order information.

12. The order prompting device according to claim 8, wherein the account information of the account placing the order comprises a communication mode of a user placing the order, and the recipient information comprises a communication mode of a recipient of the order.

13. The order prompting device according to claim 8, wherein the account information of the account placing the order comprises an address of a user placing the order, and the recipient information comprises an address of a recipient of the order.

14. The order prompting device according to claim 8, wherein the account information of the account placing the order comprises a payment account of a user placing the order, and a recipient information comprises a payment account of a recipient of the order.

15. A non-transitory computer-readable storage medium having stored therein computer instructions that, when executed by a processor of a device, cause the device to perform:
acquiring account information of an account placing an order and recipient information of the order, when the order is placed;
determining a recipient account corresponding to the recipient information when it is determined that the account information of the account placing the order and the recipient information correspond to different accounts; and
transmitting an order-placed prompt instruction for instructing a terminal logging in to the recipient account to prompt that the order has been placed.

16. The non-transitory computer-readable storage medium according to claim 15, wherein the instructions further cause the device to perform:
transmitting an order prompt sharing request message to a terminal logging in to the account placing the order, to instruct the terminal logging in to the account placing the order to prompt its user to input a prompt confirmation instruction, after it is determined that the account information of the account placing the order and the recipient information correspond to different accounts and prior to transmitting the order-placed prompt instruction; and
receiving the prompt confirmation instruction, and transmitting the order-placed prompt instruction in response to the prompt confirmation instruction.

17. The non-transitory computer-readable storage medium according to claim 15, wherein the instructions further cause the processor to perform:
acquiring order information of the order;
transmitting the order-placed prompt instruction and the order information, wherein the order-placed prompt instruction is configured to instruct the terminal logging in to the recipient account to prompt that the order has been placed and to display the order information.

18. The non-transitory computer-readable storage medium according to claim 17, wherein the instructions further cause the processor to perform:
transmitting an order information selection request message to the terminal logging in to the account placing the order, to instruct the terminal logging in to the account placing the order to prompt its user to select the order information;
receiving an order information selection confirmation instruction and determining selected order information according to the order information selection confirmation instruction; and
transmitting the order-placed prompt instruction and the selected order information, wherein the order-placed prompt instruction is configured to instruct the terminal logging in to the recipient account to prompt that the order has been placed and to display the selected order information.

19. The non-transitory computer-readable storage medium according to claim 15, wherein the account information of the account placing the order comprises a communication mode of a user placing the order, and the recipient information comprises a communication mode of a recipient of the order.

20. The non-transitory computer-readable storage medium according to claim 15, wherein the account information of the account placing the order comprises an address of a user placing the order, and the recipient information comprises an address of a recipient of the order.
